(19) United States
(12) Patent Application Publication
(10) Pub. No.: US 2010/0293908 A1
(43) Pub. Date: Nov. 25, 2010

(54) SELF-ADJUSTING FLOW DISTRIBUTOR

(76) Inventors: Garren Tooker, Brookings, OR (US); Emerson L. Noddin, Auburn, ME (US)

Correspondence Address: PATRICK R. SCANLON;PRETI FLAHERTY BELIVEAU & PACHIOS LLP, ONE CITY CENTER, PORTLAND, ME, 04112-9546, US

(21) Appl. No.: 12/784,168

(22) Filed: May 20, 2010

Related U.S. Application Data
(60) Provisional application No. 61/180,117, filed on May 20, 2009.

(51) Int. Cl. B01D 35/30; F16L 41/00

(52) U.S. Cl. 55/341.3; 137/561 A

(57) ABSTRACT

A flow distributor for dividing a gas stream into multiple output gas sub-streams and automatically adjusts the apportionment of the sub-streams. In one embodiment, the flow distributor includes a housing that is divided into a primary plenum and at least one secondary plenum, with an orifice providing fluid communication between the plenums.

### CROSS REFERENCES TO RELATED APPLICATIONS

This application claims the benefit of U.S. Provisional Application No. 61/180,117, filed May 20, 2009, which is hereby incorporated by reference.

### BACKGROUND OF THE INVENTION

This invention relates generally to flow distributors and more particularly to flow distributors that are useful in dust collectors.

Dust collectors are used in many industrial applications to remove dust or other particulate material from a particulate-laden gas stream. For example, dust collectors are used to remove fly ash from exhaust streams in power generation operations or to remove dust from process streams in mineral, mining or metal processing operations. While many types of dust collectors are available, including settling chambers, baffle chambers, cyclonic separators, wet scrubbers, and electrostatic precipitators, fabric filtration dust collectors are widely used for many industrial applications. One type of fabric filtration dust collector, commonly referred to as a “baghouse,” generally comprises a number of fabric bags through which the particulate-laden gas stream flows. As the gas stream passes through the fabric bags, the fabric material captures the entrained particulates, thereby separating the particulates from the gas stream.

To increase capacity, baghouses often comprise multiple modules, with each module having several fabric bags. In such installations, mechanical flow splitters, such as turning vanes, tapered inlet ducts, or the like, are used to split the incoming particulate-laden gas stream into multiple flow streams that are directed to corresponding baghouse modules. The incoming gas stream generally arrives at the flow splitter via a single run of ducting, in which a minimum transport velocity must be maintained to prevent precipitation of particulates in the ducting. The particulate material in the gas stream is typically either dry and abrasive or moist and sticky. Mechanical flow splitters are thus subject to wear when exposed to abrasive particulates, and the associated ducting is subject to plugging when exposed to sticky particulates.

When the incoming gas stream is divided into a plurality of sub-streams by the flow splitter, the sub-streams must be apportioned according to the changing flow demands of each sub-stream. This apportionment has traditionally been accomplished using some type of mathematical flow model to predict a natural flow distribution, based on a static design configuration of the ducting interface between the geometric requirements of the multiple flow paths interfacing with the discharge of the flow splitter and the single run of inlet ducting to the flow splitter. The problem with this traditional design approach is that the flow models are for a given static flow configuration and do not account for the changing design flow conditions caused by changing internal flow restrictions of the individual modules, which are continually modifying the parameters of the flow model. Any change in the flow resistance of any of the multiple flow streams, such as isolating a module for cleaning or maintenance, completely invalidates the calculations for the original flow model.

### SUMMARY OF THE INVENTION

The present invention provides a flow distributor that divides an incoming gas stream into multiple output gas sub-streams and automatically adjusts the apportionment of the sub-streams. In one embodiment, the flow distributor includes a housing that is divided into a primary plenum and at least one secondary plenum, with an orifice providing fluid communication between the plenums.

### DESCRIPTION OF THE DRAWINGS

FIG. 1 is a schematic front view of a system including a flow distributor and two baghouses, with one of the baghouses shown partly in section.

FIG. 2 is a schematic top view of the system of FIG. 1, with one of the baghouses shown partly in section.

FIG. 3 is a schematic front view of the flow distributor of FIGS. 1 and 2, shown in section.

FIG. 4 is a partial, cross-sectional view of the flow distributor taken along line 4-4 of FIG. 3.

### DETAILED DESCRIPTION OF THE INVENTION

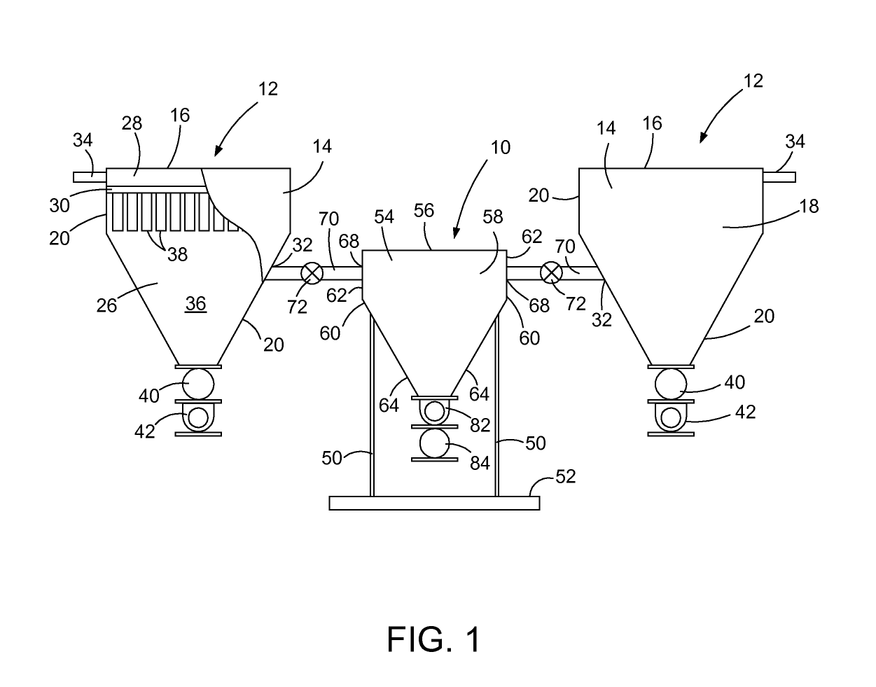

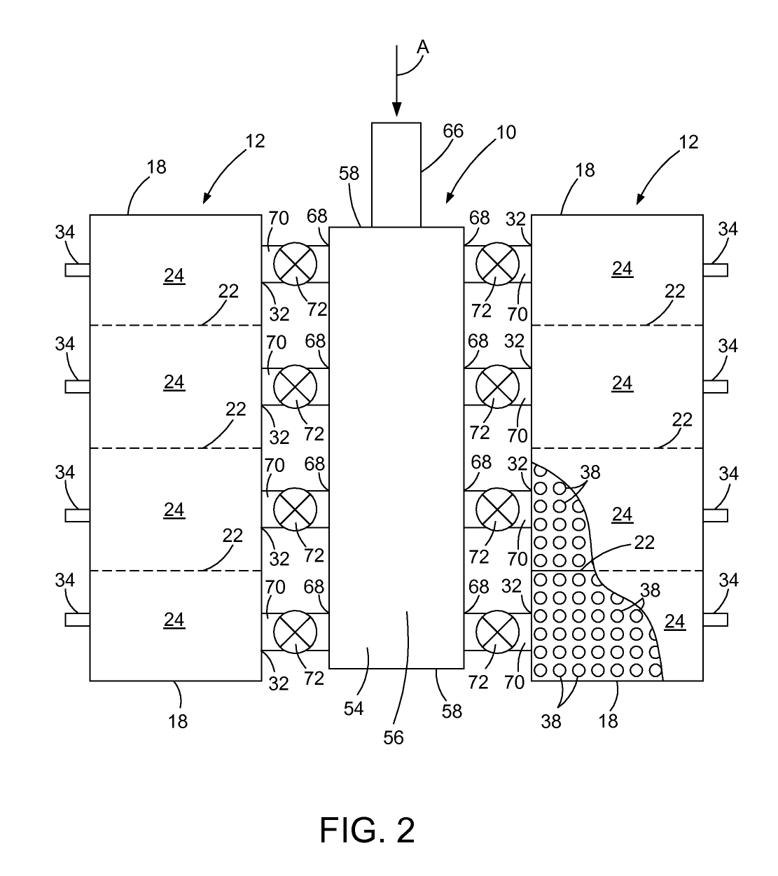

Referring to the drawings wherein identical reference numerals denote the same elements throughout the various views, FIGS. 1 and 2 show one possible embodiment of a flow distributor 10 in association with two baghouses 12. As described in more detail below, the flow distributor 10 receives a single incoming particulate-laden gas stream A and divides this gas stream into a number of sub-streams that are distributed to the baghouses 12. The sub-streams are apportioned so that the volumetric flow rate of each sub-stream is inversely proportional to the changing flow resistance encountered by that sub-stream. The flow distributor 10 is self-adjusting in that it continuously and automatically reapportions the sub-stream flow rates without any mechanical adjustments or other external inputs.

In the illustrated embodiment, each baghouse 12 is defined by an elongated, enclosed housing 14. The housing 14 is made from a suitable material, such as sheet metal, and includes a top wall 16, two opposing end walls 18, and two opposing side walls 20. A series of vertically oriented partitions 22 are disposed in the interior of the housing 14 and spaced apart along the length thereof so as to divide the baghouse 12 into four modules 24 wherein each module 24 is fluidly isolated from the other modules. It should be noted that four modules are shown by way of example only and not in a limiting sense; each baghouse 12 could comprise any number of modules. Each module 24 is divided into a lower, “dirty air” plenum 26 and an upper, “clean air” plenum 28 by a horizontal tube sheet 30. A gas inlet 32 is in fluid communication with the dirty air plenum 26, and a gas outlet 34 is in fluid communication with the clean air plenum 28. The lower portions of the housing side walls 20 are inclined to define a tapered accumulation chamber 36 at the bottom of the dirty air plenum 26.

Each tube sheet 30 has a plurality of openings formed therein for receiving a respective filter bag 38, such that each module 24 contains several filter bags 38. Each filter bag 38 is supported at its upper end by the tube sheet 30 and hangs downwardly into the dirty air plenum 26 in a substantially vertical direction. In operation, particulate-laden gas from the flow distributor 10 flows into a module 24 through the inlet 32 (via ducting described below) and enters the dirty air plenum 26. From the dirty air plenum 26, the gas passes through the filter bags 38 and into the clean air plenum 28. As the gas passes through them, the filter bags 38 filter particulates from the particulate-laden gas, resulting in clean gas entering the clean air plenum 26. From there, the clean gas exits the module 24 (and the baghouse 12) through the outlet 34. Particulates that accumulate on the exterior surfaces of the filter bags 38 can be periodically released by any suitable means (e.g., mechanical shakers, air jets, etc.) so as to fall by gravity into the accumulation chamber 36. These accumulated particulates are removed from the baghouse 12 in any suitable manner. For instance, the particulates can be removed via a rotary air lock 40 located at the bottom of the accumulation chamber 36. A conveyor, such as screw conveyor 42, can be provided for transporting the removed particulates.

The flow distributor 10 is situated between the two baghouses 12 and is supported by a number of posts 50 mounted on a foundation 52. (The baghouses 12 can be similarly supported.) In the illustrated embodiment, the flow distributor 10 comprises an elongated, enclosed housing 54 defining a hollow interior and made from any suitable material, such as sheet metal. The housing 54 has a top wall 56, two opposing end walls 58, and two opposing side walls 60. Each side wall 60 includes an upper, vertical section 62 and a lower, inclined section 64. The inclined sections 64 of the side walls 60 converge so as to provide the housing 54 with a tapered lower portion. An inlet duct 66 is connected to an opening in a first one of the end walls 58 for directing the particulate-laden gas stream A into the interior of the flow distributor 10. The housing 54 also includes a plurality of outlet openings 68 formed in each upper section 62 of the side walls 60 through which automatically apportioned sub-streams are discharged. Each outlet opening 68 is connected to a corresponding one of the baghouse inlets 32 by an outlet duct 70 for feeding an automatically apportioned sub-stream from the flow distributor 10 to the respective baghouse module 24. The outlet ducts 70 are arranged normal to the flow distributor 10 and the baghouse 12 so each sub-stream enters the respective baghouse inlet 32 normal to the baghouse face (i.e., each sub-stream flows straight into its respective baghouse module, as opposed to on an angle as is common with many conventional baghouse arrangements). Each sub-stream also enters the respective baghouse inlet 32 at a relatively low uniform velocity (i.e., a lower uniform velocity than is typical in the conventional baghouse arrangements). A valve 72, such as a motorized shut-off gate, is provided in each duct 70. The valves 72 can be individually operated to close the corresponding duct 70 to allow the respective baghouse module 24 to be taken off-line for maintenance or other purposes.

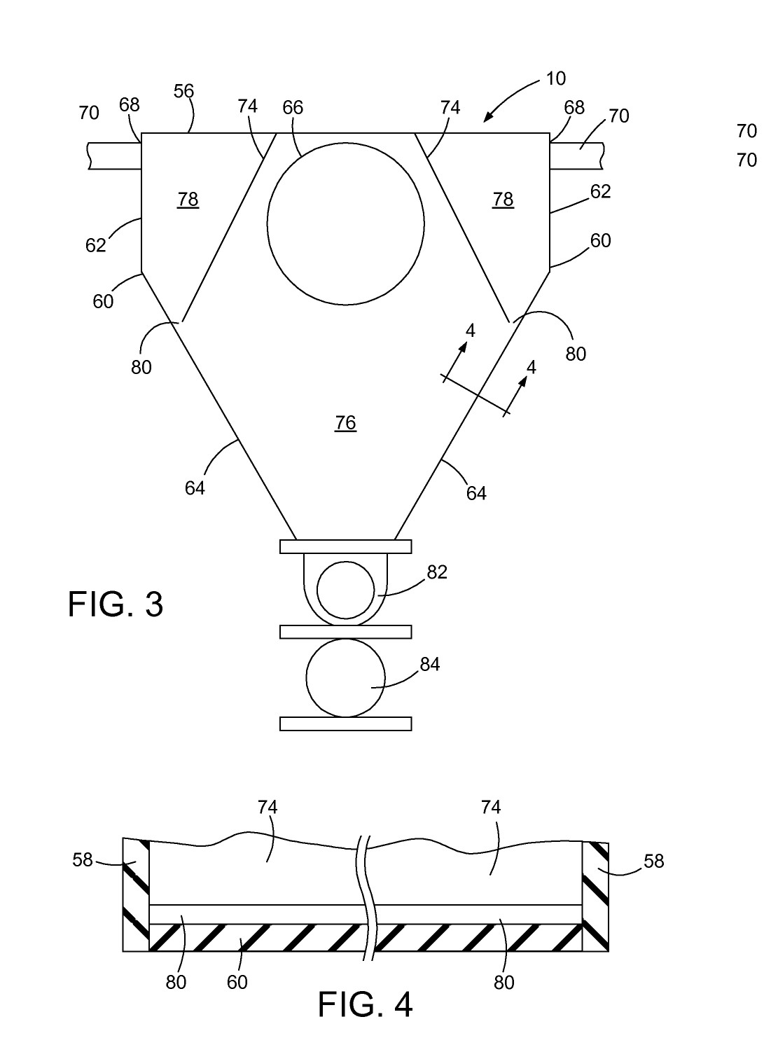

Referring to FIG. 3, the interior of the flow distributor 10 contains two divider plates 74 that divide the interior of the housing 54 into three plenum chambers: a primary plenum 76 and two secondary plenums 78. Each divider plate 74 is located on a respective side of the housing 54, generally adjacent to a corresponding upper corner of the housing interior. The divider plates 74 are inclined (approximately 30 degrees with respect to vertical) with an upper edge abutting the top wall 56 approximately midway between the corresponding corner and the midpoint of the top wall 56, and a lower edge positioned adjacent to the inclined section 64 of the respective side wall 60. The divider plates 74 also extend the full length of the housing 54 (from end wall to end wall). Thus, the primary plenum 76 occupies the central portion of the housing interior and extends the length of the housing 54, and the two secondary plenums 78 occupy the two opposing upper corners of the housing interior, respectively, and extend the length of the housing 54. The primary plenum 76 is in direct fluid communication with the inlet duct 66, and the secondary plenums are in direct fluid communication with the corresponding outlet openings 68. The lower edges of the divider plates 74 are spaced a small distance from the respective side wall 60 to define a narrow gap or slot extending the length of the housing 54, as shown in FIG. 4. Theses gaps form orifices 80 that provide fluid communication between the primary plenum 76 and the respective secondary plenum 78. Alternatively, the lower edges of the divider plates 74 could abut the side walls 60 and the orifices could be defined by a series of holes formed in the divider plates instead of the single, elongated slot.

In operation, the particulate-laden gas stream A enters the flow distributor 10 via the inlet duct 66 and flows into the primary plenum 76. The velocity of the gas stream in the inlet duct 66 is maintained at a relatively high level in order to prevent unwanted precipitation of particulates within the duct 66 (particulate precipitation in the duct 66 could result in blockage of the duct). However, as the gas stream flows into the primary plenum 76, its velocity is substantially reduced because the cross-sectional area of the primary plenum 76 is much larger than that of the inlet duct 66. This velocity reduction reduces the influence that incoming flow velocity vectors and eddy currents may have on the apportioned sub-streams discharged by the flow distributor 10 to the baghouses 12. The reduced velocity also causes some of the particulate material in the gas stream to precipitate in the primary plenum 76. Gravity causes the precipitated particulates fall downward, and these particulates are funneled to the bottom of the housing 54 by the tapered lower portion. The particulates are transported by a conveyor screw 82 located at the bottom of the housing 54 and removed from the housing 54 via a rotary airlock 84.

The gas in the primary plenum 76 passes through both of the orifices 80 into the two secondary plenums 78. As the gas passes through each orifice 80, it is reaccelerated because of the relatively narrow width of the orifices 80. In addition to increasing the velocity of gas flow, this equalizes the flow distribution along the length of the housing 54. Preferably, the gas is reaccelerated to a velocity such that the velocity pressure of the gas passing through the orifices 80 is increased sufficiently to realize the desired isolation between the primary plenum 76 and the secondary plenums 78. Generally, the desired isolation can be attained by increasing the velocity pressure of the gas passing through the orifices 80 to ten times the mean velocity pressure in both the primary and secondary plenums. This extent of increase is not too low so as to be ineffective, but is not also too high so as to require too much power to attain.

As the reaccelerated gas flows into the secondary plenums 78, its velocity is again substantially reduced because the cross-sectional area of the secondary plenums 78 is much larger than that of the orifices 80. The gas in the secondary plenums 78 is divided into a number of gas sub-streams, with each sub-stream flowing into a respective one of the active baghouse modules 24 through the corresponding ducts 70. That is each active, on-line module 24 (i.e., any module 24 for which the corresponding valve 72 is open) receives a gas sub-stream from the flow distributor 10. Because the gas flowing in the secondary plenums 78 has very low flow energy that is equalized along the length of the housing 54, the gas will be readily apportioned to the sub-streams in an amount inversely proportional to the flow resistance of each sub-stream. More specifically, the energy consumed in acceleration of the flow velocities in the ducts 70 and the internal flow resistance associated with each sub-stream is independent of the internal flow resistance of the flow distributor 10 and determines the quantity of gas that will be apportioned to each sub-stream. Those apportionments will be inversely proportional to the internal flow resistance plus acceleration energy consumed by any individual sub-stream divided by the sum total of the internal flow resistance plus acceleration consumed by all sub-streams.

The flow distributor 10 will automatically adjust the apportionment of the sub-streams to compensate for differences in their operating differential pressure. For example, if the flow resistance in a module 24 increases because of a build-up of particulate material on the filter bags 38, the flow distributor 10 will automatically compensate for this. The flow distributor 10 will also automatically reapportion the sub-streams to the remaining active, on-line modules to compensate for one or more modules 24 being taken off-line for filter media cleaning or other purposes. Furthermore, the flow distributor 10 provides double isolation between the single incoming gas flow stream A and the apportioned gas sub-streams discharged by the flow distributor 10. This double isolation eliminates the influence that the flow vectors and eddy currents associated with the high velocity incoming gas stream A may have on the sub-streams. Another benefit is that the flow distributor 10 will greatly extend the life of the filter bags 38. One reason for this is that the load on the filter bags is reduced because a large amount (typically over 50%) of the particulate material in the incoming gas stream falls out and is collected in the bottom of the flow distributor 10 due the velocity reduction in the primary plenum 76 described above. In addition, the reduced load on the filter bags 38 means that the bags need to be cleaned less often. This not only saves wear on the bags 38 but also reduces emissions and power consumption.

What is claimed is:

1. A flow distributor for dividing a gas stream into multiple sub-streams, said flow distributor comprising:
a housing defining a primary plenum and at least one secondary plenum;
an inlet duct for directing said gas stream into said primary plenum;
an orifice providing fluid communication between said primary plenum and said secondary plenum; and
a plurality of outlet openings through which said sub-streams are discharged from said secondary plenum, wherein each sub-stream is automatically apportioned so that its volumetric flow rate is inversely proportional to the flow resistance encountered by said sub-stream.

2. The flow distributor of claim 1 wherein said housing defines another secondary plenum in addition to said primary plenum and said at least one secondary plenum, said flow distributor further comprising:
an additional orifice providing fluid communication between said primary plenum and said another secondary plenum; and
an additional plurality of outlet openings through which additional sub-streams are discharged from said another secondary plenum, wherein each additional sub-stream is automatically apportioned so that its volumetric flow rate is inversely proportional to the flow resistance encountered by said additional sub-stream.

3. The flow distributor of claim 1 wherein said housing has a tapered lower portion.

4. The flow distributor of claim 1 wherein said orifice is configured so as to equalize flow distribution along the length of said housing.

5. The flow distributor of claim 1 wherein said orifice is configured so as to increase the velocity pressure of gas passing therethrough above the mean velocity pressure in said primary plenum and said first secondary plenum.

6. A flow distributor comprising:
a housing defining a hollow interior that includes a primary plenum and a first secondary plenum;
an inlet duct in direct fluid communication with said primary plenum, said primary plenum having a larger cross-sectional area than said inlet duct;
a first set of outlet openings in direct fluid communication with said first secondary plenum; and
a first orifice providing fluid communication between said primary plenum and said first secondary plenum, said first secondary plenum having a larger cross-sectional area than said first orifice.

7. The flow distributor of claim 6 wherein said housing further includes a second secondary plenum and said flow distributor further comprises:
a second set of outlet openings in direct communication with said second secondary plenum; and
a second orifice providing fluid communication between said primary plenum and said second secondary plenum, said second secondary plenum having a larger cross-sectional area than said second orifice.

8. The flow distributor of claim 7 further comprising first and second divider plates located in said hollow interior so as to divide said hollow interior into said primary plenum and said first and second secondary plenums.

9. The flow distributor of claim 8 wherein said first divider plate has a lower edge that is spaced from a first side wall of said housing to define a narrow gap that forms said first orifice, and said second divider plate has a lower edge that is spaced from a second side wall of said housing to define a narrow gap that forms said second orifice.

10. The flow distributor of claim 9 wherein said first and second orifices both extend the length of said housing.

11. The flow distributor of claim 7 wherein said primary plenum occupies a central portion of said hollow interior and extends the length of said housing, said first secondary plenum occupies a first corner of said hollow interior and extends the length of said housing, and said second secondary plenum occupies a second corner of said hollow interior and extends the length of said housing.

12. The flow distributor of claim 6 wherein said housing has a tapered lower portion.

13. The flow distributor of claim 6 wherein said first orifice is configured so as to equalize flow distribution along the length of said housing.

14. The flow distributor of claim 6 wherein said first orifice is configured so as to increase the velocity pressure of gas passing therethrough above the mean velocity pressure in said primary plenum and said first secondary plenum.

15. A system comprising:
at least one baghouse having a plurality of modules, wherein each module contains multiple filter bags;
a flow distributor for dividing a gas stream into a plurality of automatically apportioned sub-streams; and
a plurality of outlet ducts connected between said flow distributor and said baghouse for feeding each sub-stream to a corresponding one of said plurality of modules.

16. The system of claim 15 wherein said flow distributor comprises:
a housing defining a hollow interior that includes a primary plenum and at least one secondary plenum;
an inlet duct for directing said gas stream into said primary plenum;
an orifice providing fluid communication between said primary plenum and said secondary plenum; and
a plurality of outlet openings formed in said housing in direct fluid communication with said secondary plenum, wherein each one of said outlet ducts is connected to a corresponding one of said outlet openings.

17. The system of claim 16 wherein said primary plenum has a larger cross-sectional area than said inlet duct and said secondary plenum has a larger cross-sectional area than said orifice.

18. The system of claim 15 wherein each sub-stream is automatically apportioned so that its volumetric flow rate is inversely proportional to the flow resistance encountered by said sub-stream.

19. The system of claim 15 further comprising a valve provided in each outlet duct.

20. The system of claim 15 wherein said orifice is configured so as to equalize flow distribution along the length of said housing.

21. The system of claim 15 wherein each outlet duct is positioned normal to said baghouse so that each sub-stream flows straight into said baghouse.

22. The system of claim 15 wherein each sub-stream enters said baghouse at a relatively lower uniform velocity.
